(19) United States
(12) Patent Application Publication
(10) Pub. No.: US 2026/0233738 A1
(43) Pub. Date: Aug. 13, 2026

(54) APPARATUS, METHOD, AND PROGRAM PRODUCT FOR PARKING ASSISTANCE

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Kazuma IWAZAWA, Tokyo (JP); Norio IMAI, Tokyo (JP)

(21) Appl. No.: 19/530,001

(22) Filed: Feb. 4, 2026

(30) Foreign Application Priority Data
Feb. 7, 2025 (JP) 2025-019488

(51) Int. Cl. B60W 30/14

(52) U.S. Cl. CPC B60W 30/143; B60W 2540/225; B60W 2552/53

(57) ABSTRACT

In an apparatus for parking assistance of a host vehicle, a parking space detector detects one or more parking spaces in which the host vehicle is parkable. A gaze direction acquisition unit acquires a gaze direction of an occupant of the host vehicle. A parking space determiner determines, based on the acquired gaze direction, one of the one or more parking spaces as a target parking space in which the host vehicle is to be parked.

### CROSS REFERENCE TO RELATED APPLICATION

This application is based on and claims the benefit of priority from Japanese Patent Application No. 2025-019488 filed on February 7, 2025, the disclosure of which is incorporated in its entirety herein by reference.

### TECHNICAL FIELD

The present disclosure relates to apparatuses, methods, and program products for parking assistance.

### BACKGROUND

Japanese Patent Application Publication No. 2021-94927 discloses a parking assistance apparatus that controls a host vehicle to park at a target parking position based on recognition information obtained by recognizing a surrounding environment of the host vehicle. The parking assistance apparatus includes a parkable position detection unit and a target parking position determination unit.

The parkable position detection unit detects one or more parkable positions from the recognition information. When a plurality of parkable positions are detected by the parkable position detection unit, the target parking position determination unit extracts a predetermined number or less of candidate parking positions from the detected parkable positions based on distances between a current position of the host vehicle and the respective parkable positions, and displays the candidate parking positions on a display device. Then, the target parking position determination unit selects, from the displayed candidate parking positions, one of the displayed candidate parking positions as a target parking position for the host vehicle.

For example, the target parking position determination unit may extract, as the candidate parking positions, a predetermined number of parkable positions in descending order of proximity to the current position of the host vehicle. Alternatively, the target parking position determination unit may extract, as the candidate parking positions, a predetermined number or less (e.g., one) of parkable positions that are each located within a predetermined travel distance from the current position of the host vehicle. This configuration of the parking assistance apparatus enables, when a plurality of parkable positions are detected, the parkable positions to be presented to a user in an easily understandable manner.

### SUMMARY

As described above, the conventional technology determines the candidate parking positions based on the distances from the current position of the host vehicle. However, the candidate parking positions determined in this manner do not always match a position where an occupant (e.g., a driver) of the host vehicle actually intends to park. This may require the occupant to perform an additional operation to select or set a target parking position other than the displayed or presented candidate parking positions, thereby increasing the occupant's workload.

In view of the above circumstances, the present disclosure provides a technology that makes parking assistance easier to use for an occupant (e.g., a driver) of a host vehicle.

A first aspect of the present disclosure provides an apparatus for parking assistance of a host vehicle. The apparatus includes a parking space detector configured to detect one or more parking spaces in which the host vehicle is parkable, a gaze direction acquisition unit configured to acquire a gaze direction of an occupant of the host vehicle, and a parking space determiner configured to determine, based on the acquired gaze direction, one of the one or more parking spaces as a target parking space in which the host vehicle is to be parked.

A second aspect of the present disclosure provides a method of parking assistance of a host vehicle. The method includes detecting one or more parking spaces in which the host vehicle is parkable, acquiring a gaze direction of an occupant of the host vehicle, and determining, based on the acquired gaze direction, one of the one or more parking spaces as a target parking space in which the host vehicle is to be parked.

A third aspect of the present disclosure provides a parking assistance program product that includes anon-transitory storage medium, and program instructions stored in the non-transitory storage medium. The program instructions cause a processor to detect one or more parking spaces in which the host vehicle is parkable, acquire a gaze direction of an occupant of the host vehicle, and determine, based on the acquired gaze direction, one of the one or more parking spaces as a target parking space in which the host vehicle is to be parked.

Note that each parenthesized reference character assigned to a corresponding element in the present disclosure merely represents an example of a relationship between the corresponding element and a corresponding specific element described in an exemplary embodiment described later, and therefore the present disclosure is not limited to the parenthesized reference characters.

### BRIEF DESCRIPTION OF THE DRAWINGS

Other aspects of the present disclosure will become apparent from the following description of embodiments with reference to the accompanying drawings in which:

FIG. 1 is a plan view schematically illustrating packing assistance for a host vehicle in which an in-vehicle system including a parking assistance apparatus according to a present embodiment of the present disclosure is installed;

FIG. 2 is a block diagram illustrating a schematic configuration of the in-vehicle system illustrated in FIG. 1;

FIG. 3 is a block diagram illustrating a schematic functional configuration implemented by a parking assistance apparatus illustrated in FIG. 2;

FIG. 4 is a plan view illustrating schematic operations of the parking assistance apparatus illustrated in FIG. 3;

FIG. 5 is a flowchart illustrating a parking assistance control routine to be carried out by the parking assistance apparatus illustrated in FIG. 3;

FIG. 6 is a flowchart illustrating a parking speed reduction routine to be carried out by the parking assistance apparatus illustrated in FIG. 3; and

FIG. 7 is a plan view illustrating schematic operations of the parking assistance apparatus illustrated in FIG. 3.

### DETAILED DESCRIPTION OF EMBODIMENTS

The following describes exemplary embodiments or specific examples of the present disclosure with reference to the accompanying drawings. It should be noted that the following embodiments, modifications thereof, and the descriptions in the drawings associated therewith are schematized or simplified for the purpose of briefly explaining the contents of the present disclosure, and the contents of the present disclosure are not limited thereby. Therefore, it goes without saying that the descriptions in the drawings do not necessarily match specific apparatus configurations that are actually manufactured and sold. That is, unless explicitly limited by the applicant during the prosecution of the application, the present disclosure should not be interpreted as being limited by the descriptions in the drawings or by the descriptions of the apparatus configurations, functions, or operations described below corresponding thereto.

### Overall configuration of in-vehicle system

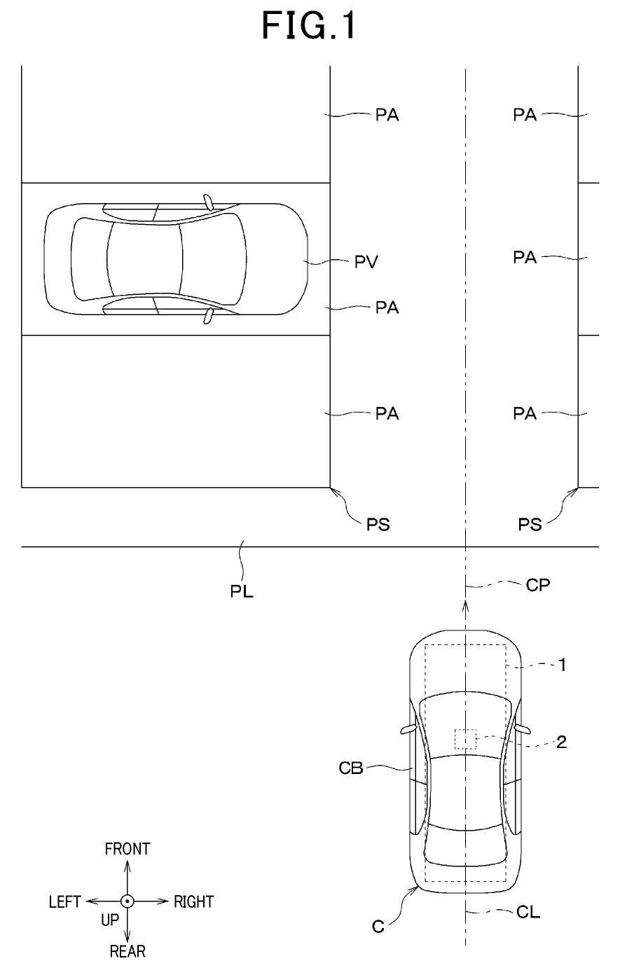

Referring to FIG. 1, an in-vehicle system 1 is installed in a host vehicle C as a mobility system. The host vehicle C is a four-wheel motor vehicle, and has a body CB having a substantially rectangular shape in plan view. The shape of each part of the host vehicle C in plan view refers to a shape of the part when viewed along a line of sight identical to the direction of gravity in a state where the host vehicle C is stably placed on a horizontal plane so as to be travelable.

The host vehicle C has a center line CL defined as a virtual line that passes through a center point of the host vehicle C in its width direction and extends in parallel with a front-rear direction, i.e., a longitudinal direction, of the host vehicle C. The center line CL will also be referred to as a longitudinal center line or a vehicle center line.

The vehicle center line CL, which is shown by the arrow, indicates the movement direction of the host vehicle C while the host vehicle C is traveling in a forward direction. The state where the host vehicle C is traveling in the forward direction (hereinafter referred to as “forward traveling”) means that the traveling speed of the host vehicle C (i.e., vehicle speed) is greater than or equal to zero and that the current shift position of a shift lever of the host vehicle C is set to any traveling position except for a reverse position. The “traveling position” means any position of the shift lever other than a parking position and a neutral position. The movement direction of the host vehicle C, which is shown by the vehicle center line CL, matches the traveling direction of the host vehicle C when the host vehicle C is traveling straight, and is the direction of a tangent to a travel path of the host vehicle C when the host vehicle C is steering.

The longitudinal direction of the host vehicle C is a direction perpendicular to both the width direction and a height direction of the host vehicle C. The height direction is a direction that defines the height of the host vehicle C and is parallel with the direction of gravity of the host vehicle C while the host vehicle C is mounted movably and stably on the plane of horizon.

In the host vehicle C, a front direction, a rear direction, a left direction, a right direction, and an upper direction are defined as directions indicated by arrows illustrated in FIG. 1. That is, the vehicle longitudinal direction is synonymous with the front-rear direction, and the vehicle width direction is synonymous with the left-right direction. A scheduled traveling route of the host vehicle C when the host vehicle C is in the forward traveling will be referred to as an estimated route CP illustrated by two-dot chain line in FIG. 1.

The in-vehicle system 1 is configured to detect one or more objects present around the host vehicle C using, for example, a camera 2, and to execute, based on the detected one or more objects as the detection results, (i) traveling control of the host vehicle C and (ii) an information notification operation to one or more occupants of the host vehicle C. The in-vehicle system 1 of the exemplary embodiment has a configuration as a so-called parking assist system. That is, the in-vehicle system 1 is configured to detect, based on images of the surroundings of the host vehicle C captured by the camera 2, one or more parking spaces PS and one or more parked vehicles PV located around the host vehicle C. Then, the in-vehicle system 1 is configured to execute a parking assist operation for the host vehicle C based on the one or more parking spaces PS and the one or more parked vehicles PV.

It should be noted that “parking assistance” includes, but is not limited to, “automatic parking” in which the in-vehicle system 1 automatically performs all of shift operations, steering operations, and pedal operations of an occupant (i.e., a driver) of the host vehicle C instead of the occupant. That is, in addition to automatic parking, “parking assistance” includes a first parking mode in which the in-vehicle system 1 automatically performs the steering operations and pedal operations while the occupant of the host vehicle performs the shift operations, and a second parking mode in which the in-vehicle system 1 automatically performs the steering operations while the occupant performs both the shift operations and the pedal operations. The in-vehicle system 1 of the exemplary embodiment is configured to be capable of executing automatic parking.

The parking space PS is a space configured to accommodate one passenger vehicle. Each parking space PS is typically comprised of a parking section PA that is defined by partition lines, such as white lines, on a road surface in a parking lot PL as illustrated in FIG. 1. However, the present disclosure is not limited to above configuration. Specifically, the parking space PS may be defined as a sufficient parkable space between parked vehicles PV arranged continuously in the same direction in a quantity greater than or equal to a predetermined number (e.g., two or more). In such an example, although the parking space PS is not a space surrounded by partition lines, a virtual rectangular space similar to a space defined by partition lines may be defined.

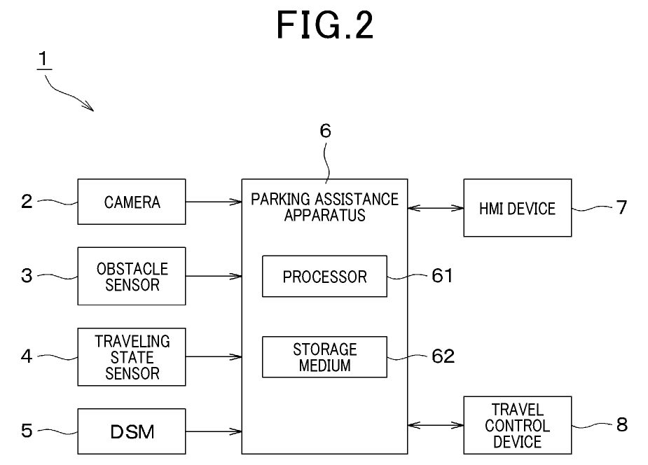

FIG. 2 illustrates a schematic configuration of the in-vehicle system 1. As illustrated in FIG. 2, the in-vehicle system 1 includes the camera 2, obstacle sensors 3, traveling state sensors 4, a driver status monitor 5, a parking assistance apparatus 6, an HMI device 7, and a travel control device 8. HMI is an abbreviation for Human Machine Interface.

The camera 2 is mounted to the host vehicle C to capture images around the host vehicle C. The camera 2 of the present embodiment is a so-called front camera and is installed to have an imaging range in front of and diagonally forward of the host vehicle C. The camera 2 is connected to the parking assistance apparatus 6 via an in-vehicle communication line installed in the host vehicle C to enable signal and/or information communication therebetween and is configured to input detection data including the captured images to the parking assistance apparatus 6.

The obstacle sensors 3 are mounted to the host vehicle C to detect one or more obstacles present around the host vehicle C. Specifically, one or more of radar sensors, one or more of laser radar sensors, and/or one or more of ultrasonic sensors are mounted to the host vehicle C as the obstacle sensors 3. The obstacle sensors 3 are connected to the parking assistance apparatus 6 via the in-vehicle communication line to enable signal and/or information communication therebetween and is configured to input detection data including the detected obstacles around the host vehicle C to the parking assistance apparatus 6.

The traveling state sensors 4 are mounted to the host vehicle C to detect various quantities related to the traveling state of the host vehicle C. The “quantities related to the traveling state” include, for example, quantities related to driving operations by a driver or an automated driving system, such as the current accelerator operation amount, the current brake operation amount, the current shift position, and the current steering angle of the host vehicle C. The automated driving system of the present embodiment refers to the in-vehicle system 1 and corresponds to a driving assistance system or an autonomous driving system. Furthermore, the "quantities related to the traveling state" include, for example, physical quantities related to the various behaviors of the host vehicle C, such as the current speed, the current angular velocity, the current longitudinal acceleration, and the current lateral acceleration of the host vehicle C.

That is, the traveling state sensors 4 collectively refer to known sensors necessary for vehicle driving control, such as an accelerator position sensor, a steering angle sensor, wheel speed sensors, an angular velocity sensor, an acceleration sensor, a yaw rate sensor, and the other sensors, for simplification of illustration and description. The traveling state sensors 4 are connected to the parking assistance apparatus 6 via the in-vehicle communication line to enable signal and/or information communication therebetween and are configured to input detection data including the detected quantities related to the driving state of the host vehicle C to the parking assistance apparatus 6.

The driver status monitor 5 is mounted to the host vehicle C to detect a gaze direction of a driver who is one of one or more occupants of the host vehicle C and executes various driving operations of the host vehicle C. Specifically, the driver status monitor 5 is configured to capture images of the head, face, and eyeballs of the driver using an in-cabin camera disposed inside the cabin of the host vehicle C to thereby detect the gaze direction of the driver. The driver state monitor 5 is connected to the parking assistance apparatus 6 via the in-vehicle communication line to enable signal and/or information communication therebetween and is configured to input detection data including the detected driver’s state to the parking assistance apparatus 6. Because the configuration of the driver status monitor 5 is already known at the filing date of the present application, detailed descriptions thereof will be omitted.

The parking assistance apparatus 6 is installed inside the body CB of the host vehicle C. The parking assistance apparatus 6 is configured to control parking assistance operations of the host vehicle C based on the various types of detection data items, i.e., information and/or signals, detected by the camera 2, the obstacle sensors 3, the traveling state sensors 4, and the driver status monitor 5. That is, the parking assistance apparatus 6 is configured to control operations of respective units installed in the host vehicle C, including the HMI device 7 and the travel control device 8, related to parking assistance of the host vehicle C.

The parking assistance apparatus 6 of the present embodiment is configured as an in-vehicle computer including at least a processor 61 and a storage medium 62. The processor 61 is comprised of at least one CPU and/or MPU. CPU is an abbreviation for Central Processing Unit. MPU is an abbreviation for Micro Processor Unit.

The storage medium 62 is comprised of at least one non-transitory tangible storage medium, such as ROM or a nonvolatile rewritable memory. ROM is an abbreviation for Read Only Memory. The nonvolatile rewritable memory is a storage device, such as a flash ROM, configured to allow stored information to be rewritten and to retain the stored information even when power is not supplied. The processor 61 is configured to read and execute one or more control programs stored in the storage device 62 to cause the parking assistance apparatus 6 to control overall operations of the in-vehicle system 1. Details of functions of the parking assistance apparatus 6 will be described later.

The HMI device 7 includes, for example, a display device and a speaker, and is configured to provide various kinds of information and warnings to the one or more occupants of the host vehicle C. The travel control device 8 is configured to execute longitudinal and/or lateral motion control of the host vehicle C. That is, the travel control device 8 is configured to be capable of executing at least part of motion control such as starting, acceleration/deceleration, braking, stopping, steering, and the other motions for the host vehicle C.

### Parking assistance device

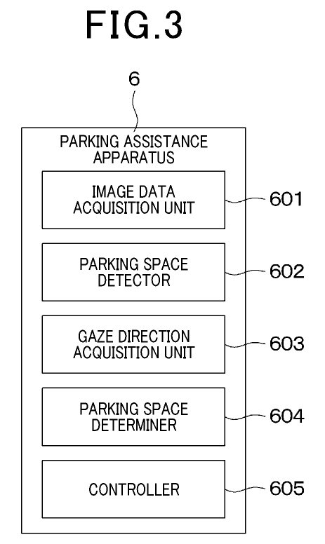

The processor 61 is configured to read at least a parking assistance program and a parking speed reduction program stored in the storage device 62 and execute the parking assistance program and the parking speed reduction program, thus causing the in-vehicle computer of the parking assistance device 6 to implement a functional configuration thereon, a part of which is illustrated in FIG. 3.

As illustrated in FIG. 3, the parking assistance apparatus 6 includes, as functional blocks implemented thereon, an image data acquisition unit 601, a parking space detector 602, a gaze direction acquisition unit 603, a parking space determiner 604, and a controller 605.

The following describes the details of the functional configuration of the parking assistance apparatus 6 with reference to FIGS. 1 to 3.

The image data acquisition unit 601 acquires the image data generated by the camera 2. Specifically, the image data acquisition unit 601 receives, from the camera 2, the image data based on images captured by the camera 2, and stores a predetermined capacity of the image data, starting from the latest data.

The parking space detector 602 executes a known image recognition technology based on the image data acquired by the image data acquisition unit 601 to detect one or more parking space PS in each of which the host vehicle C is parkable. Because various methods of detecting parking spaces in each of which a vehicle is parkable has been already known at the filing date of the present application, detailed descriptions thereof will be omitted.

The gaze direction acquisition unit 603 acquires a gaze direction of an occupant of the host vehicle C. Specifically, the gaze direction acquisition unit 603 receives the gaze direction of the driver detected by the driver status monitor 5.

The parking space determiner 604 determines, based on the one or more parking spaces PS in each of which the host vehicle C is parkable detected by the parking space detector 602, a target parking space in which the host vehicle C is to be parked. If the parking spaces PS in each of which the host vehicle C is parkable are detected, the parking space determiner 604 selects one of the detected parking spaces PS based on the gaze direction of the driver acquired by the gaze direction acquisition unit 603, thus determining the target parking space.

The controller 605 generates, based on the target parking space, which is determined by the parking space determiner 604 and agreed by the driver of the host vehicle C, vehicle control information required to park the host vehicle C in the target parking space, and outputs the vehicle control information to selected units installed in the host vehicle C; the selected units include the HMI device 7 and the travel control device 8. That is, the controller 605 calculates a travel route from the current position of the host vehicle C to the target parking space, calculates motion control commands, such as a commanded traveling speed and a commanded steering amount based on the travel route, and outputs the motion control commands to the travel control device 8. Moreover, the controller 605 causes the HMI device 7 to output information that needs to be notified to a selected occupant, such as the driver, of the host vehicle C during traveling of the host vehicle C from the current position to the target parking space.

Additionally, the controller 605 of the present embodiment variably determines the traveling speed of the host vehicle C during parking assistance, that is, during traveling toward the target parking space, in accordance with the fluctuating state of the driver’s gaze direction acquired by the gaze direction acquisition unit 603. Specifically, the controller 605 reduces the traveling speed of the host vehicle C when the amount of fluctuation in the gaze direction is greater than a predetermined threshold.

### How parking assistance device operate

The following describes how the parking assistance device 6 operates and how the parking assistance method and program are executed, together with their advantageous effects, with reference to the corresponding drawings. In the following description, the parking assistance device 6 according to the present embodiment and the parking assist method and the parking assist program executed by the parking assistance apparatus 6 may be collectively referred to simply as the present embodiment.

The image data acquisition unit 601 acquires the image data based on images of the surroundings of the host vehicle C captured by the camera 2. The parking space detector 602 detects the one or more parking space PS using a known image recognition technology based on the image data acquired by the image data acquisition unit 601.

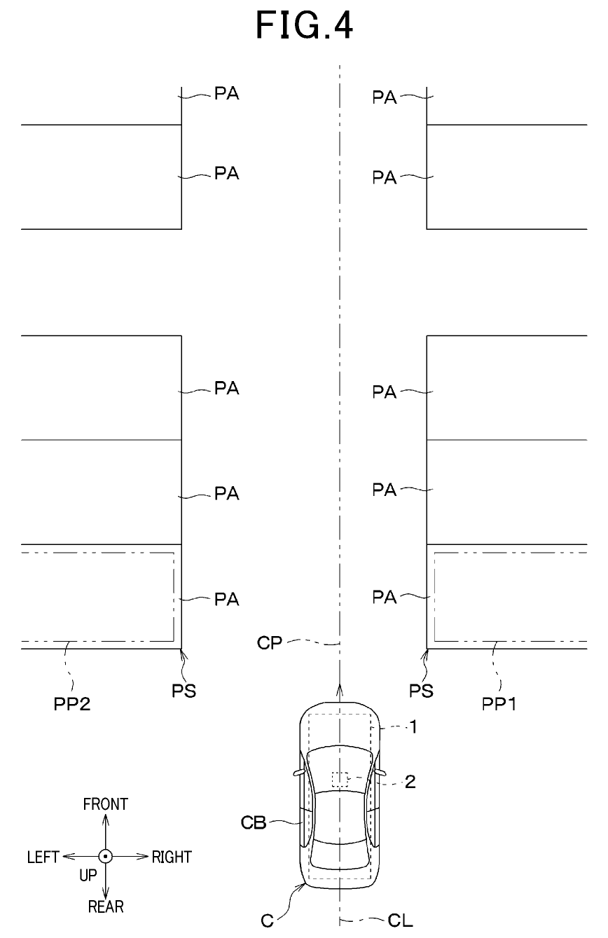

FIG. 4 illustrates a specific example where a travel lane (drive aisle) extends substantially straight in a parking lot, and a plurality of parking spaces PS in each of which the host vehicle C is parkable are arranged continuously along the travel lane on both the left and right sides of the trave lane. In this example, the estimated straight travel path CP of the host vehicle C is located along the travel lane.

The host vehicle C of the present embodiment is, for example, a so-called right-hand-drive vehicle, and it is assumed that the row of parking spaces PS on the right side of the estimated travel path CP is closer to the estimated travel path CP than the row of parking spaces PS on the left side thereof is.

In the example illustrated in FIG. 4, vehicles are to be parked back-in such that the front end of each vehicle faces the travel lane.

In this example, a conventional parking assistance technology sets, as a target parking space, a selected parking space PS from the parking spaces PS on the right side, which is located closest to the host vehicle C; the selected parking space PS is also referred to as a first parking space PP1.

However, there may be a case where it is preferable for an occupant, in particular, the driver, of the host vehicle C to park the host vehicle C in a selected parking space PS from the parking spaces PS on the left side, which is located closest to the host vehicle C; the selected parking space PS is also referred to as a second parking space PP2.

Specifically, for example, the left-side parking spaces PS may be closer to a building to be visited. Alternatively, for example, because the host vehicle C is a right-hand-drive vehicle, if another vehicle is parked in a parking space adjacent to the driver’s side of the first parking space PP1 after the host vehicle C, the driver returning later may have difficulty entering the host vehicle C due to, for example, reduced door-opening clearance.

In such a case where the driver of the host vehicle C is intended to park the host vehicle C the second parking space PP2 on the left side, the driver of the host vehicle C gazes at the left-side row of parking spaces PS or the second parking space PP2 in which the driver is intended to park the host vehicle C.

The gaze direction acquisition unit 603 acquires the driver’s gaze direction oriented to the left-side row of parking spaces PS or the second parking space PP2 detected by the driver status monitor 5. Then, the parking space determiner 604 selects the second parking space PP2 closest to the host vehicle C among the left-side row of parking spaces PS based on the gaze direction, and determines the selected second parking space PP2 as the target parking space.

As described above, the present embodiment determines the target parking space based on the driver’s gaze direction. This therefore makes it possible to reduce a burden on an occupant, such as a driver, of the host vehicle C who would otherwise be required to manually select or set a target parking space different from a candidate parking space displayed or proposed by the in-vehicle system 1. This results in a time required from start of parking assistance of the host vehicle C to completion of parking of the host vehicle C being shortened. This therefore makes it possible to further improve the usability of the parking assistance for an occupant, such as a driver, of the host vehicle C.

After determination of the target parking space, the driver’s gaze may unstably shift during the parking assistance traveling of the host vehicle C (e.g., the driver may look around). In such a case, it is assumed that the driver checking their surroundings more cautiously for safely confirmation. Therefore, the controller 605 reduces the traveling speed of the host vehicle C when the amount of fluctuation in the gaze direction is greater than the predetermined threshold. This therefore makes it possible to execute appropriate parking assistance control of the host vehicle C in accordance with the intention and/or awareness of one or more occupants, such as a driver, of the host vehicle C.

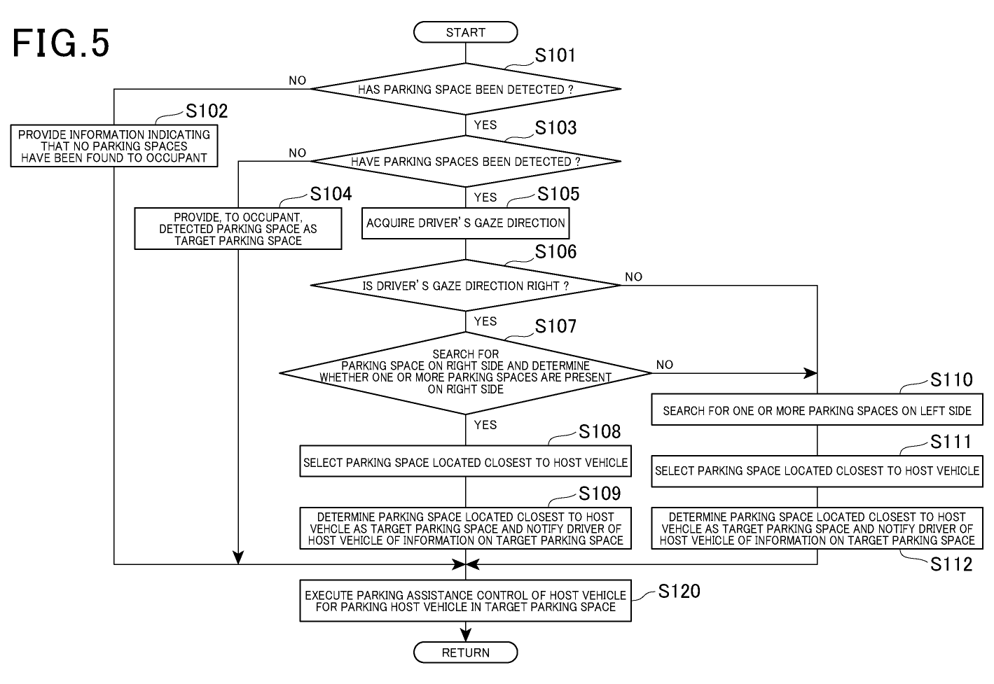

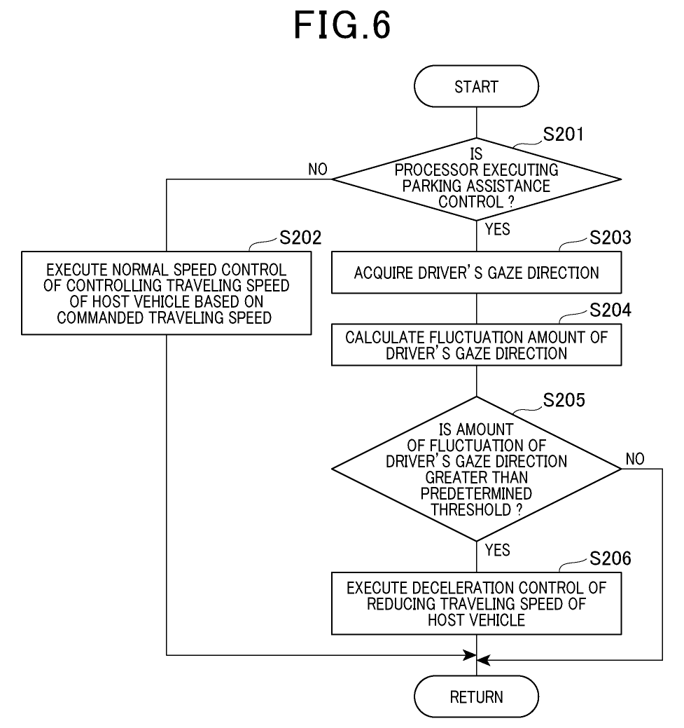

FIG. 5 is a flowchart showing a parking assistance control routine based on the parking assistance control program, and FIG. 6 is a flowchart showing a parking speed reduction routine based on the parking speed reduction program. In these flowcharts, “S” is an abbreviation for “step.”

The processor 61 is configured to start the parking assistance control routine illustrated in FIG. 5 in response to, for example, starting parking assistance of the host vehicle C. Additionally, the processor 61 is configured to cyclically execute the parking speed reduction routine illustrated in FIG. 6 at predetermined time intervals (for example, 10 msec).

When starting the parking assistance control routine illustrated in FIG. 5, the processor 61 serves as, for example, the parking space detector 602 to determine whether at least one parkable parking space PS has been detected for the host vehicle C based on, for example, the image data including captured images of the surroundings of the host vehicle C acquired by the image data acquisition unit 601 in step S101.

When no parkable parking space PS have been detected (NO in step S101), the processor 61 instructs the HMI device 7 to provide information indicating that no parkable parking spaces PS have been found to the one or more occupants of the host vehicle C in step S102 and thereafter temporarily terminates the parking assistance control routine illustrated in FIG. 5. For example, after a predetermined time has elapsed since the termination of the parking assistance control routine in step S102 so that the host vehicle C has moved from the current position, the processor 61 executes again the parking assistance control routine.

In step S102, the processor 61 instructs the HMI device 7 to provide information indicating that no parkable parking spaces PS have been found to the one or more occupants of the host vehicle C.

Otherwise, when at least one parkable parking space PS has been detected (YES in step S101), the parking assistance control routine proceeds to step S103.

In step S103, the processor 61 serves as, for example, the parking space detector 602 to determine whether a plurality of parkable parking spaces PS have been detected for the host vehicle C.

In response to determination that only one parkable parking space PS has been detected (NO in step S103), the processor 61 selects, i.e., determines, the detected parking space PS as the target parking space and provides, i.e., proposes, the target parking space to the one or more occupants of the host vehicle C in step S104. Thereafter, the parking assistance control routine proceeds to step S120.

Otherwise, in response to determination that a plurality of parkable parking spaces PS have been detected for the host vehicle C (YES in step S103), the parking assistance control routine proceeds to the sequence of steps S105 and S106.

Specifically, the processor 61 serves as, for example, the gaze direction acquisition unit 603 to acquire the driver’s gaze direction detected by the driver status monitor 5 in step S105. Next, the processor 61 serves as, for example, the parking space determiner 604 to determine whether the acquired driver’s gaze direction is toward the right in step S106.

In response to determination that the driver’s gaze direction is toward the right (YES in step S106), the processor 61 sequentially executes processes in respective steps S107 to S109.

Specifically, the processor 61 serves as, for example, the parking space determiner 604 to search for one or more parkable spaces PS on the right side of the estimated travel path CP, which is indicated by the driver’s gaze, to determine whether one or more parkable parking space PS are present on the right side of the estimated travel path CP in step S107.

When one or more parkable parking space PS are determined to be present on the right side (YES in step S107), the processor 61 serves as, for example, the parking space determiner 604 to select, in step S108, a parking space PS located closest to the host vehicle C among the one or more parkable parking spaces PS located on the right side. Then, the processor 61 serves as, for example, the parking space determiner 604 to determine the selected closest parking space PS as the target parking space and instruct the HMI device 7 to notify the driver of the host vehicle C of information on the target parking space in step S109.

Otherwise, when no parkable parking space PS are determined to be present on the right side (NO in step S107), the parking assistance control routine proceeds to steps S110 to S112.

On the other hand, in response to determination that the driver’s gaze direction is toward the left (NO in step S106), the processor 61 sequentially executes processes in respective steps S110 to S112.

Specifically, the processor 61 serves as, for example, the parking space determiner 604 to search for one or more parkable spaces PS on the left side of the estimated travel path CP, which is indicated by the driver’s gaze in step S110, and to select, in step S111, a parking space PS located closest to the host vehicle C among the one or more parkable parking spaces PS located on the left side. Then, the processor 61 serves as, for example, the parking space determiner 604 to determine the selected closest parking space PS as the target parking space and instruct the HMI device 7 to notify the driver of the host vehicle C of information on the target parking space in step S112.

In response to the notification, the driver of the host vehicle C inputs, to the parking assistance device 6, agreement information that agrees with the target parking space notified by the processor 61.

After the process in step S109 or S112, the parking assistance control routine proceeds to step S120.

In step S120, the processor 61 serves as, for example, the controller 605 to receive the agreement information, and generate, based on the target parking space determined by the parking space determiner 604, the vehicle control information required to park the host vehicle C in the target parking space. Then, in step S120, the processor 61 serves as, for example, the controller 605 to output the vehicle control information to selected units installed in the host vehicle C, thus executing parking assistance control of the host vehicle C for parking the host vehicle C in the target parking space.

That is, the controller 605 calculates a travel route from the current position of the host vehicle C to the target parking space, calculates motion control commands, such as a commanded traveling speed and a commanded steering amount based on the travel route, and outputs the motion control commands to the travel control device 8 in step S120. This instructs the travel control device 8 to guide the host vehicle C toward the target parking space and assist the host vehicle C to be parked in the target parking space. After the operation in step S120, the processor 61 terminates the parking assistance control routine.

When starting the parking speed reduction routine illustrated in FIG. 6, the processor 61 serves as, for example, the controller 605 to determine whether the processor 61 is executing the parking assistance control in step S201. In response to determination that the processor 61 is not executing the parking assistance control (NO in step S201), the processor 61 serves as, for example, the controller 605 to execute normal speed control of controlling the traveling speed of the host vehicle C based on the commanded traveling speed in step S202 and thereafter temporarily terminates the parking speed reduction routine.

Otherwise, in response to determination that the processor 61 is executing the parking assistance control (YES in step S201), the processor 61 executes the process in step S203 and subsequent processes.

In step S203, the processor 61 serves as, for example, the gaze direction acquisition unit 603 to acquire the driver’s gaze direction detected by the driver status monitor 5 in step S203. Because the processor 61 cyclically executes the parking assistance routine, the processor 61 serves as, for example, the controller 605 to calculate, in step S204, a fluctuation amount of the driver’s gaze direction based on a difference between the gaze direction acquired in a current execution cycle and the gaze direction acquired in a previous execution cycle.

Next, the processor 61 serves as, for example, the controller 605 to determine, in step S205, whether the calculated amount of fluctuation in the driver’s gaze direction is greater than the predetermined threshold.

When the amount of fluctuation in the driver’s gaze direction is greater than the predetermined threshold (YES in step S205), the processor 61 serves as, for example, the controller 605 to execute deceleration control of reducing the traveling speed of the host vehicle C in step S206. Otherwise, when the amount of fluctuation in the driver’s gaze direction is smaller than or equal to the predetermined threshold (NO in step S205), the processor 61 skips the process in step S206 and temporarily terminates the parking speed reduction routine illustrated in FIG. 6.

### Modifications

While the exemplary embodiment of the present disclosure has been described above, the present disclosure is not limited to the exemplary embodiment. Specifically, the present disclosure includes various modifications and/or alternatives of the exemplary embodiment within the scope of the present disclosure.

The following describes typical modifications of the exemplary embodiment. In the typical modifications, to the same parts or equivalent parts of the exemplary embodiment, like reference characters are assigned, so that, as the descriptions of each of the same or equivalent parts of the typical modifications, the descriptions of the corresponding one of the same or equivalent parts of the exemplary embodiment can be employed unless technical contradiction or otherwise specified.

The present disclosure is not limited to the specific hardware configuration described in the above-described embodiment. For example, the host vehicle C is not limited to a right-hand-drive vehicle, and may be a left-hand-drive vehicle, or a vehicle in which a driver seat is provided at the center position in the vehicle width direction. Further, the host vehicle C is not limited to a so-called four-wheeled passenger vehicle, and may be a large vehicle.

The in-vehicle system 1 may have a configuration capable of implementing at least one of automated driving, advanced driver assistance, automatic parking, parking assistance, and the like. That is, the parking assistance apparatus 6 may have a configuration as an “ADAS ECU” that controls ADAS operations of the host vehicle C. ADAS is an abbreviation for Advanced Driver-Assistance Systems. ECU is an abbreviation for Electronic Control Unit or Electric Control Unit. In this modification, the parking assistance apparatus 6 may be integrated, i.e., unified, with the travel control device 8.

The camera 2 is not limited to a so-called front camera and may be an omnidirectional camera. There is no particular limitation on the number of cameras or the mount positions of the cameras. There is also no particular limitation on a type, number, or mount positions of the obstacle sensors 3.

All or part of the parking assistance apparatus 6 may have a configuration including a digital circuit, such as an ASIC or an FPGA, configured to be capable of executing the above-described operations. ASIC is an abbreviation for Application Specific Integrated Circuit. FPGA is an abbreviation for Field Programmable Gate Array. That is, in the parking assistance apparatus 6, an in-vehicle microcomputer portion and a digital circuit portion may coexist.

The computer programs, i.e., computer-program instructions, described in the present embodiment, which cause the processor 61 to execute various operations, tasks, and/or procedures set forth above, can be downloaded into the storage medium 62 or upgraded using vehicle-to-everything (V2X) communications. The computer-program instructions can be downloaded and/or upgraded through terminals; the terminals are provided in, for example, a manufacturing factor of the host vehicle C, a garage, or an authorized distributor. The computer programs can be stored in a memory card, an optical disk, or a magnetic disk, accessible to the processor 61 which can read out. That is, the memory card, optical disk, or magnetic disk can serve as the storage medium 62.

Each functional configuration and each process described above according to the present disclosure can be implemented by at least one dedicated computer including a memory and a processor programmed to perform one or more functions embodied by one or more computer programs.

Each functional configuration and each process described above according to the present disclosure can also be implemented by at least one dedicated computer including a processor comprised of one or more dedicated hardware logic circuits.

Each functional configuration and each process described above according to the present disclosure can further be implemented by at least one processor system comprised of a memory, a processor programmed to perform one or more functions embodied by one or more computer programs, and one or more hardware logic circuits.

Each functional configuration and each process described above according to the present disclosure can further be implemented by a hardware logic circuit.

The one or more programs can be stored in a computer-readable non-transitory storage medium as instructions to be carried out by a computer or a processor. That is, each functional configuration and each process described above according to the present disclosure can further be implemented by at least one computer program including the procedure for implementing the corresponding functional configuration and the corresponding process or by a non-transitory storage medium that stores the compute program.

Accordingly, the functional blocks, such as the image data acquisition unit 601 illustrated in FIG. 3, are merely functional configuration blocks that are conveniently defined to facilitate understanding of the present disclosure. Therefore, even if these functional blocks are not actually implemented as subroutines and/or hardware within the parking assistance apparatus 6, requirements of the present disclosure can be satisfied as long as functions and/or processing specified in the present disclosure are implemented.

Detection of the driver’s gaze direction may be performed by a driver gaze detection device for display control of an AR-type head-up display, instead of the driver status monitor 5. AR is an abbreviation for Augmented Reality. Such a head-up display is configured to project display image light constituting a display image onto a predetermined projection region on the front windshield of the host vehicle C so as to display the display image in AR manner.

The image data acquisition unit 601 and the parking space detection unit 602 may be provided in the travel control device 8 serving as a so-called ADAS ECU. That is, the parking assistance apparatus 6 may acquire, from the travel control device 8, a detection result of the parking spaces PS. In other words, the parking space detection unit 602 may be a parking space acquisition unit.

The present disclosure is not limited to the specific operation modes shown in the above embodiment. That is, for example, each parking space PS is not limited to one for parallel parking, and may be one for diagonal parallel parking or tandem parking.

The parking space determination unit 604 may determine the second parking space PP2 as the target parking space based on the driver gazing at the second parking space PP2. That is, the gaze direction acquisition unit 603 may acquire not only whether the driver’s gaze direction is right or left, but also whether the gaze direction is far right, far left, near right, or near left. Alternatively, the gaze direction acquisition unit 603 may acquire a fine detection result of the driver’s gaze direction for each parking space PS.

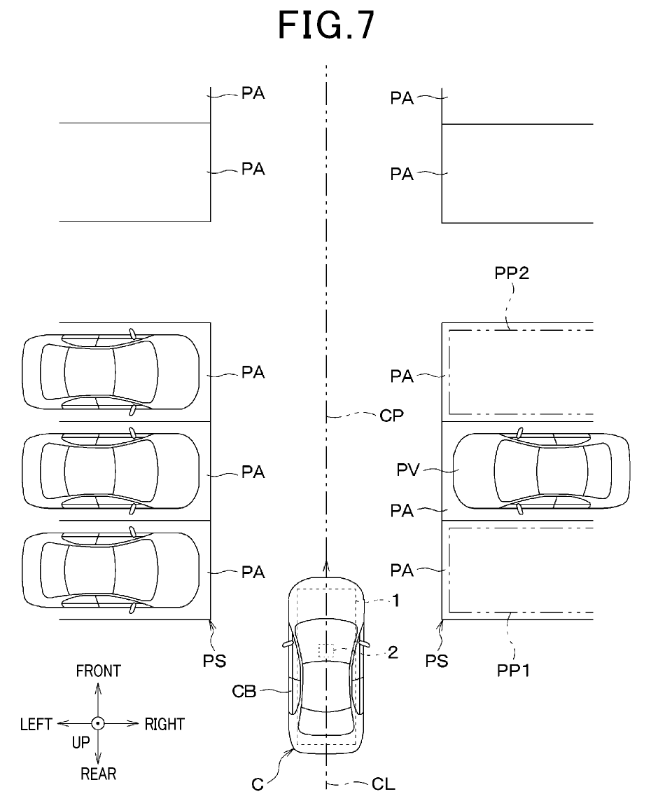

Specifically, in the example of FIG. 7, three consecutive parking spaces PS on the left side of the straight estimated travel path CP of the host vehicle C are respectively occupied by parked vehicles PV, and the host vehicle C is not parkable in the three consecutive parking spaces PS.

On the other hand, among three consecutive parking spaces PS on the right side of the estimated travel path CP, there are no parked vehicles in respective two spaces, namely, a front-side first parking space PP1 and a rear-side second parking space PP2, are available. In this case, when the driver of the host vehicle C directs the driver’s gaze toward the rear-side second parking space PP2, the parking assistance device 6 sets, as the target parking space, the second parking space PP2 being gazed at by the driver, rather than the front-side first parking space PP1.

In fully automated driving, a driver may not be present in the host vehicle C. In this case, the gaze direction acquisition unit 603 may acquire a gaze direction of an occupant in the host vehicle C. That is, instead of, or in addition to, the driver status monitor 5 illustrated in FIG. 2, a device for detecting a gaze direction of an occupant other than the driver may be mounted to the own vehicle C.

One or more components in the present embodiment are not necessarily essential components except for (i) one or more components that are described as one or more essential components or (ii) one or more components that are essential in principle.

Specific values disclosed in the present embodiment, each of which represents the number of components, a physical quantity, and/or a range of a physical parameter, are not limited thereto except that (i) the specific values are obviously essential or (ii) the specific values are essential in principle.

The specific structure and direction of each component described in the present embodiment are not limited thereto except for cases in which (1) the specific structure and direction are described to be essential or (2) the specific structure and direction are required in principle. Additionally, the specific structural or functional relationship between components described in the present embodiment is not limited thereto except for cases in which (1) the specific structural or functional relationship is described to be essential or (2) the specific structural or functional relationship is required in principle.

Similar expressions, such as “obtaining”, “calculation”, “estimation”, “detection”, and “determination”, can be mutually substituted for one another unless the substitution produces technological inconsistency. The expression that A is more than (greater than or other similar expressions) or equal to B, and the expression that A is more than B can be substituted for one another unless the substitution produces technological inconsistency. Similarly, the expression that A is less than (smaller than or other similar expressions) or equal to B, and the expression that A is less than B can be substituted for one another unless the substitution produces technological inconsistency. Storage media may be rephrased as recording media. Non-transient tangible storage media may also be referred to as non-transitory recording media.

Modifications of the present disclosure are not limited to those described set forth above. For example, specific examples described set forth above can be combined with each other unless the combination produces technological inconsistency, and similarly the modifications set forth above can be combined with each other unless the combination produces technological inconsistency. At least part of the exemplary embodiment can be combined with at least part of the modifications set forth above unless the combination produces technological inconsistency.

As clearly seen by the descriptions of the present embodiment and its modification, the present disclosure includes the following technological concepts.

### Technological Concept 1-1

The technological concept 1-1 provides an apparatus for parking assistance of a host vehicle. The apparatus includes a parking space detector configured to detect one or more parking spaces in which the host vehicle is parkable, a gaze direction acquisition unit configured to acquire a gaze direction of an occupant of the host vehicle, and a parking space determiner configured to determine, based on the acquired gaze direction, one of the one or more parking spaces as a target parking space in which the host vehicle is to be parked.

### Technological Concept 1-2

In the apparatus of the technological concept 1-2, which depends from the technological concept 1-1, the parking space determiner is configured to, when the parking space detector detects the parking spaces, select, based on the acquired gaze direction, one of the parking spaces as the target parking space.

### Technological Concept 1-3

The apparatus of the technological concept 1-3, which depends from the technological concept 1-1 or 1-2, includes a controller configured to generate control information including a traveling speed of the host vehicle in accordance with an amount of fluctuation of the acquired gaze direction.

### Technological Concept 1-4

In the apparatus of the technological concept 1-4, which depends from the technological concept 1-3, the controller is configured to determine whether the amount of fluctuation of the acquired gaze direction is greater than a predetermined threshold, and reduce the traveling speed of the host vehicle when the amount of fluctuation of the acquired gaze direction is greater than the predetermined threshold.

### Technological Concept 2-1

The technological concept 2-1 provides a method of parking assistance of a host vehicle. The method includes detecting one or more parking spaces in which the host vehicle is parkable, acquiring a gaze direction of an occupant of the host vehicle, and determining, based on the acquired gaze direction, one of the one or more parking spaces as a target parking space in which the host vehicle is to be parked.

### Technological Concept 2-2

In the method of the technological concept 2-2, which depends from the technological concept 2-1, the determining comprises, when the detecting detects the parking spaces, selecting, based on the acquired gaze direction, one of the parking spaces as the target parking space.

### Technological Concept 2-3

The method of the technological concept 2-3, which depends from the technological concept 2-1 or 2-2, further includes generating control information including a traveling speed of the host vehicle in accordance with an amount of fluctuation of the acquired gaze direction.

### Technological Concept 2-4

The method of the technological concept 2-4, which depends from the technological concept 2-3, further includes determining whether the amount of fluctuation of the acquired gaze direction is greater than a predetermined threshold, and reducing the traveling speed of the host vehicle when the amount of fluctuation of the acquired gaze direction is greater than the predetermined threshold.

### Technological Concept 3-1

The technological concept 3-1 provides a parking assistance program product that includes a non-transitory storage medium, and program instructions stored in the non-transitory storage medium. The program instructions cause a processor to detect one or more parking spaces in which the host vehicle is parkable, acquire a gaze direction of an occupant of the host vehicle, and determine, based on the acquired gaze direction, one of the one or more parking spaces as a target parking space in which the host vehicle is to be parked.

### Technological Concept 3-2

In the program product of the technological concept 3-2, which depends from the technological concept 3-1, the program instructions cause the processor to, when the parking spaces are detected, select, based on the acquired gaze direction, one of the parking spaces as the target parking space.

### Technological Concept 3-3

In the program product of the technological concept 3-3, which depends from the technological concept 3-1 or 3-2, the program instructions cause the processor to generate control information including a traveling speed of the host vehicle in accordance with an amount of fluctuation of the acquired gaze direction.

### Technological Concept 3-4

In the program product of the technological concept 3-4, which depends from the technological concept 3-3, the program instructions cause the processor to determine whether the amount of fluctuation of the acquired gaze direction is greater than a predetermined threshold, and reduce the traveling speed of the host vehicle when the amount of fluctuation of the acquired gaze direction is greater than the predetermined threshold.

### Technological Concept 4-1

The technological concept 4-1 provides a non-transitory storage medium storing program instructions. The program instructions cause a processor to detect one or more parking spaces in which the host vehicle is parkable, acquire a gaze direction of an occupant of the host vehicle, and determine, based on the acquired gaze direction, one of the one or more parking spaces as a target parking space in which the host vehicle is to be parked.

### Technological Concept 4-2

In the non-transitory storage medium of the technological concept 4-2, which depends from the technological concept 4-1, the program instructions cause the processor to, when the parking spaces are detected, select, based on the acquired gaze direction, one of the parking spaces as the target parking space.

### Technological Concept 4-3

In the non-transitory storage medium of the technological concept 4-3, which depends from the technological concept 4-1 or 4-2, the program instructions cause the processor to generate control information including a traveling speed of the host vehicle in accordance with an amount of fluctuation of the acquired gaze direction.

### Technological Concept 4-4

In the non-transitory storage medium of the technological concept 4-4, which depends from the technological concept 4-3, the program instructions cause the processor to determine whether the amount of fluctuation of the acquired gaze direction is greater than a predetermined threshold, and reduce the traveling speed of the host vehicle when the amount of fluctuation of the acquired gaze direction is greater than the predetermined threshold.

1. An apparatus for parking assistance of a host vehicle, the apparatus comprising:
a parking space detector configured to detect one or more parking spaces in which the host vehicle is parkable;
a gaze direction acquisition unit configured to acquire a gaze direction of an occupant of the host vehicle; and
a parking space determiner configured to determine, based on the acquired gaze direction, one of the one or more parking spaces as a target parking space in which the host vehicle is to be parked.

2. The apparatus according to claim 1, wherein:
the parking space determiner is configured to, when the parking space detector detects the parking spaces, select, based on the acquired gaze direction, one of the parking spaces as the target parking space.

3. The apparatus according to claim 1, further comprising:
a controller configured to generate control information including a traveling speed of the host vehicle in accordance with an amount of fluctuation of the acquired gaze direction.

4. The apparatus according to claim 3, wherein:
the controller is configured to:
determine whether the amount of fluctuation of the acquired gaze direction is greater than a predetermined threshold; and
reduce the traveling speed of the host vehicle when the amount of fluctuation of the acquired gaze direction is greater than the predetermined threshold.

5. A method of parking assistance of a host vehicle, the method comprising:
detecting one or more parking spaces in which the host vehicle is parkable;
acquiring a gaze direction of an occupant of the host vehicle; and
determining, based on the acquired gaze direction, one of the one or more parking spaces as a target parking space in which the host vehicle is to be parked.

6. The method according to claim 5, wherein:
the determining comprises, when the detecting detects the parking spaces, selecting, based on the acquired gaze direction, one of the parking spaces as the target parking space.

7. The method according to claim 5, further comprising:
generating control information including a traveling speed of the host vehicle in accordance with an amount of fluctuation of the acquired gaze direction.

8. The method according to claim 7, further comprising:
determining whether the amount of fluctuation of the acquired gaze direction is greater than a predetermined threshold; and
reducing the traveling speed of the host vehicle when the amount of fluctuation of the acquired gaze direction is greater than the predetermined threshold.

9. A parking assistance program product comprising:
a non-transitory storage medium;
program instructions stored in the non-transitory storage medium, the program instructions causing a processor to:
detect one or more parking spaces in which the host vehicle is parkable;
acquire a gaze direction of an occupant of the host vehicle; and
determine, based on the acquired gaze direction, one of the one or more parking spaces as a target parking space in which the host vehicle is to be parked.

10. The parking assistance program product according to claim 9, wherein:
the program instructions cause the processor to, when the parking spaces are detected, select, based on the acquired gaze direction, one of the parking spaces as the target parking space.

11. The parking assistance program product according to claim 9, wherein:
the program instructions cause the processor to generate control information including a traveling speed of the host vehicle in accordance with an amount of fluctuation of the acquired gaze direction.

12. The parking assistance program product according to claim 11, wherein:
the program instructions cause the processor to:
determine whether the amount of fluctuation of the acquired gaze direction is greater than a predetermined threshold; and
reduce the traveling speed of the host vehicle when the amount of fluctuation of the acquired gaze direction is greater than the predetermined threshold.
